(19) United States
(12) Patent Application Publication
(10) Pub. No.: US 2005/0009477 A1
(43) Pub. Date: Jan. 13, 2005

(54) System and method for an upconverter for stacked intermediate frequency carriers

(75) Inventors: Shlomo Rakib, Cupertino, CA (US); Oren Arad, Palo Alto, CA (US); Robert Fanfelle, Redwood City, CA (US)

Correspondence Address: Robert E. Krebs;Thelen Reid & Priest, LLP, P.O. Box 640640, San Jose, CA, 95164-0640, US

(73) Assignee: Terayon Communications System, Inc., a Delaware Corporation

(21) Appl. No.: 10/618,186

(22) Filed: Jul. 10, 2003

(51) Int. Cl. H04B 1/02; H04B 1/66; H04B 1/04; H01Q 11/12

(52) U.S. Cl. 455/102; 455/118

(57) ABSTRACT

A system for outputting a broadband signal outputs a number of input channel streams. The input channel streams first arrive at the system in a digital format. There the input channel streams are each directed to a modulator circuit. Each particular modulator circuit produces a digital upconverted signal for the associated channel streams. The outputs of the modulators are coupled to a summer circuit. Accordingly the summer circuit digitally sums the outputs of the modulator circuits. The summer circuit is coupled to a digital to analog converter (DAC). The DAC produces an analog signal from the digitally summed output of the summer circuit. The DAC is in turn coupled to an upconverter. The upconverter upconverts the analog output of the DAC into an output signal centered on a particular frequency.

### FIELD OF THE INVENTION

The present invention relates to a modulated communication system. More particularly, the present invention is related to sending multiple data streams into multiple carriers in a radio frequency (RF) band.

### BACKGROUND

Typically, when sending multiple data streams on multiple carriers in a RF band, the system contains a large number of analog devices. In a typical system performing the broadband propagation, each of the multiple signals is carried within a subrange of the broadband RF spectrum sent out.

To accomplish this, a typical system employs a signal generation branch for each of the outgoing data streams. For example, in the case of a single exemplary data stream, the stream would enter the system as a digital signal. This digital signal is modulated in the digital domain, and this digital signal is relayed to a digital to analog converter (DAC). The DAC converts the digital signal into an analog signal confined to a subsignal contained within the broadband spectrum. This output signal is then relayed to a broadband RF transmitter along with the other subsignals, where they are transmitted to the external environment. In some cases, the signal is filtered prior to being sent out on the broadband transmitter.

In a typical broadband output system, each individual datastream subsignal contained within the output broadband signal is individually converted to the appropriate analog signal. In this manner, each signal is individually operated on by such components as a quadrature modulator or intermediate frequency (IF) modulator subsequent to being converted. Typically, each signal is individually filtered prior to being relayed to the broadband transmitter. Accordingly, for each data stream present in a broadband signal, a typical broadband system will have a dedicated DAC for each data stream, individual analog components, such as a quadrature modulator or an IF modulator for each data stream, and individual filtering components for each data stream within the ultimate broadband signal.

FIG. 1 is frequency domain diagram of a broadband transmission in accordance with the prior art having 6 different subcarrier bands, each containing a single data stream. The subchannel represented in band A is produced from one particular branch of the broadband system. A digital stream corresponding to the data in subchannel A is directed into the system and modulated to be carried in the subchannel A. The various subchannels are typically upconverted in the analog domain by separate elements after. Thus, eaxh stream is typically first modulated, then upconverted into the specific range in the broadband spectrum prior to being combined with one another.

### SUMMARY

A system for outputting a broadband signal is contemplated, where the broadband signal is made of number of input channel streams. The input channel streams first arrive at the system in a digital format. There the input channel streams are each directed to a modulator circuit. Each particular modulator circuit produces a digital upconverted signal for the associated channel streams. The outputs of the modulators are coupled to a summer circuit. Accordingly the summer circuit digitally sums the outputs of the modulator circuits. The summer circuit is coupled to a digital to analog converter (DAC). The DAC produces an analog signal from the digitally summed output of the summer circuit. The DAC is in turn coupled to an upconverter. The upconverter upconverts the analog output of the DAC into an output signal centered on a particular frequency.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention. The Figures contained in this disclosure are as follows:

FIG. 1 is frequency domain diagram of a broadband transmission in accordance with the prior art having 6 different subcarrier bands, each containing a single data stream;

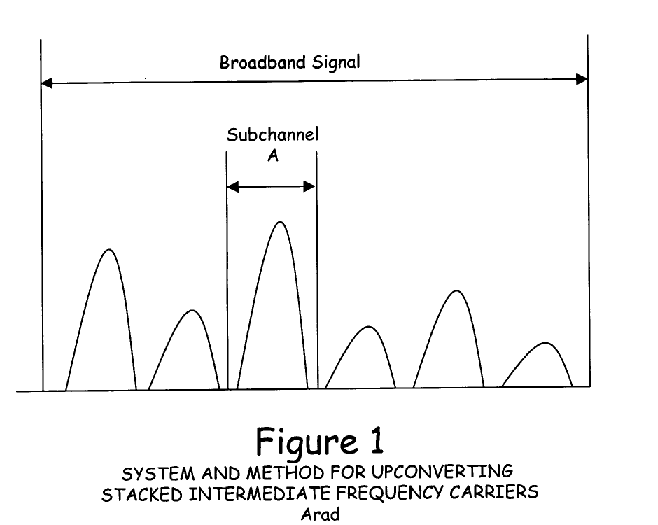

FIG. 2 is a schematic diagram of an upconverter in accordance with the invention;

FIG. 3 is a signal diagram detailing the construction of the digital streams into a final signal at the various stages in accordance with the invention;

FIG. 4 is a schematic diagram alternative embodiment of the summation in accordance with the invention;

FIG. 5 is a schematic diagram detailing embodiment of the invention in terms of an I/Q modulation technique in accordance with the invention;

FIG. 6 is a schematic diagram of embodiment of the invention in terms of an alternative modulation technique used with an IF modulator in accordance with the invention.

### DETAILED DESCRIPTION

Embodiments of the present invention are described herein in the context of a system and method for an upconverter for stacked intermediate frequency carriers. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of digital systems, including hardware, software, or any combination thereof. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

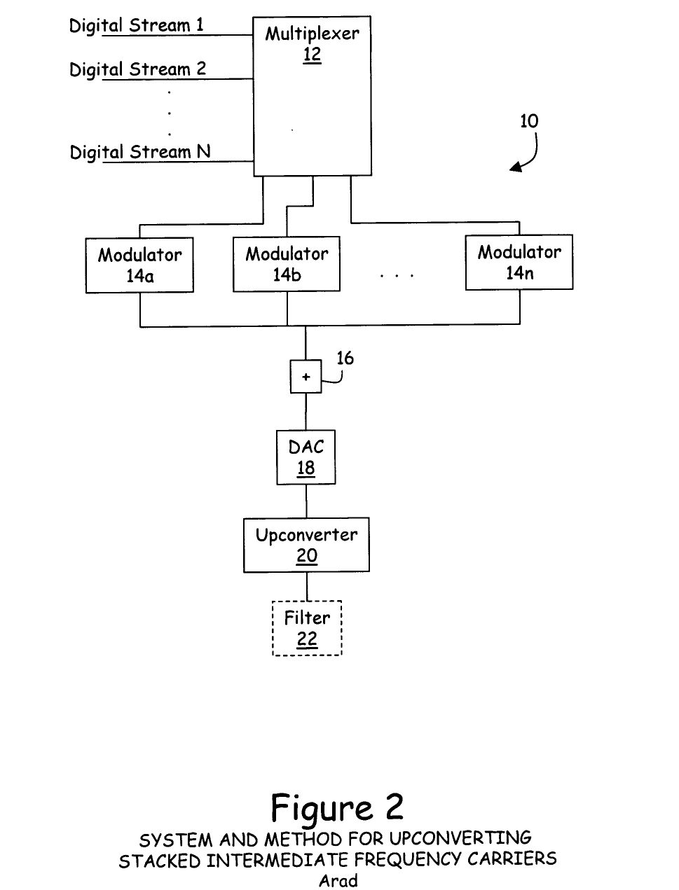

FIG. 2 is a schematic diagram of an upconverter in accordance with the invention. A system 10 is used to modulate multiple streams of data onto multiple RF carriers. The input to the system is a stream of binary or digital data, and the output of the system is N channels. The input stream may consist of any number of input physical streams from 1 to M (M>N), where the multiplexer maps the appropriate logical data streams into the N physical output channels. In this manner, for example, such communications systems can carry a number of logical streams, which are sent through a few physical channels (modulators).

The streams in the shown embodiment are sent into a multiplexer 12. The multiplexer 12 distributes the stream into the various output channels. Of course, the stream need not be an intermixed stream requiring the use of the multiplexer 12. In this alternative setup, the individual digital data streams may be input directly into the specific processing stream. Or, the system may contain a mix of individual streams of digital data and streams requiring the use of the multiplexer 12.

In any case, a particular digital stream is directed to a particular modulator from among those shown, namely modulators 14a-n. In the present example, 4 channels are shown, but any number can be contemplated.

Each of the modulators 14a-n produces a digital signal indicative of an output on a particular sub-channel in the system. The outputs of the modulators 14a-d are summed in the digital domain in a summer 16. The summer 16 produces a digital representation of the full broadband output signal corresponding to the final output of the broadband transmitter.

The output of the summer 16 is coupled to a DAC 18. The DAC 18 produces an analog signal from the digital representation of the full broadband output signal produced by the summer 16. The DAC operates on the digitally summed streams of data emanating from the various modulators 14a-n.

An upconverter 20 receives the summed signal from the DAC 18. The upconverter 20 then upconverts the now-summed broadband signal into a RF signal centered on a desired RF frequency.

An optional final analog component 22 may be implemented. Such final components can include such components as RF filters, or any other analog component previously duplicated in the multiple path systems of the prior art.

At the output of the system 10, the final broadband signal is completed and awaits transmission. Accordingly, a RF transmitter 24 that completes the system need not aggregate various analog signal, since the final signal emanating from the upconverter 20 is the final broadband signal.

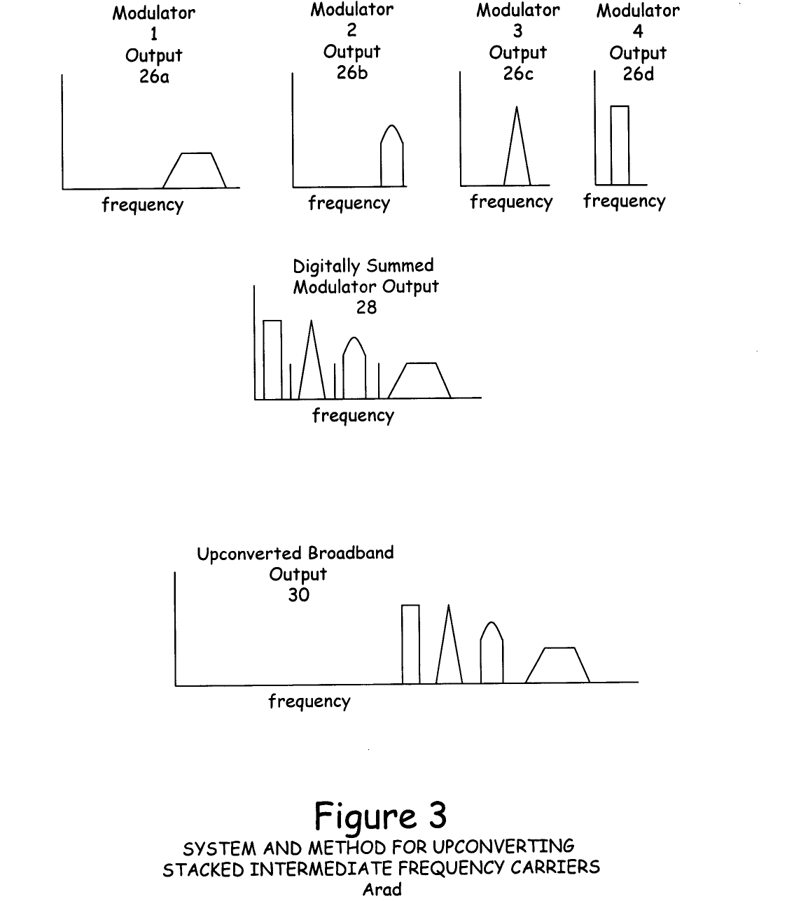

FIG. 3 is a signal diagram detailing the construction of the digital streams into a final signal at the various stages in accordance with the invention. This example assumes four input signals, although any number may be imagined. The four input signals are first modulated, as shown in 26a-d. After summing, the band-limited signals of 26a-d are changed into a single digital wide-band signal 28. This wide band signal is upconverted and transformed to the analog domain, as depicted as signal 30, and output to the external environement.

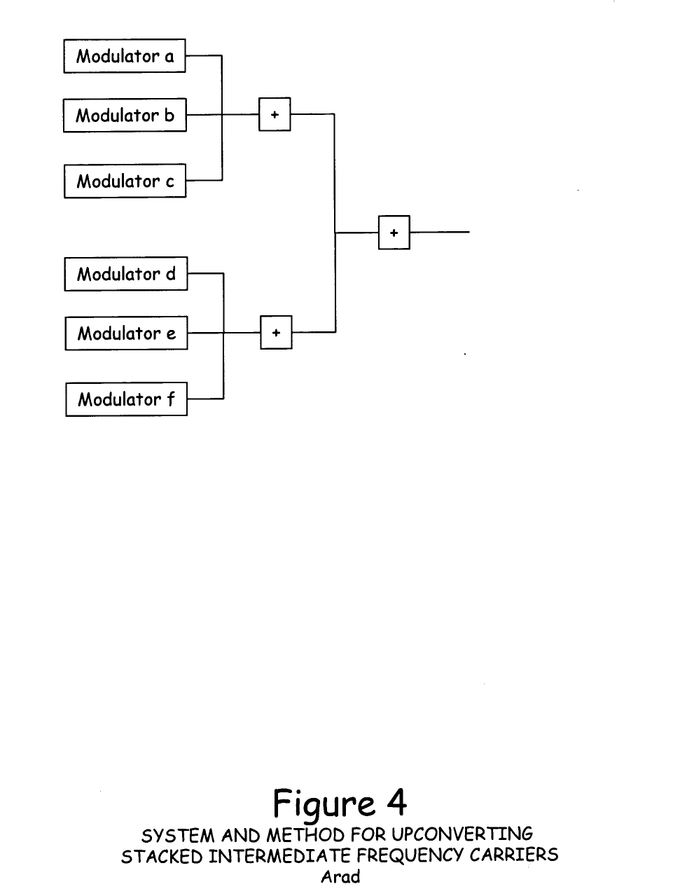

FIG. 4 is a schematic diagram of an alternative embodiment of the single summation circuit in accordance with the invention. In this manner, the summations may be cascaded, allowing for greater throughput on the individual digital components.

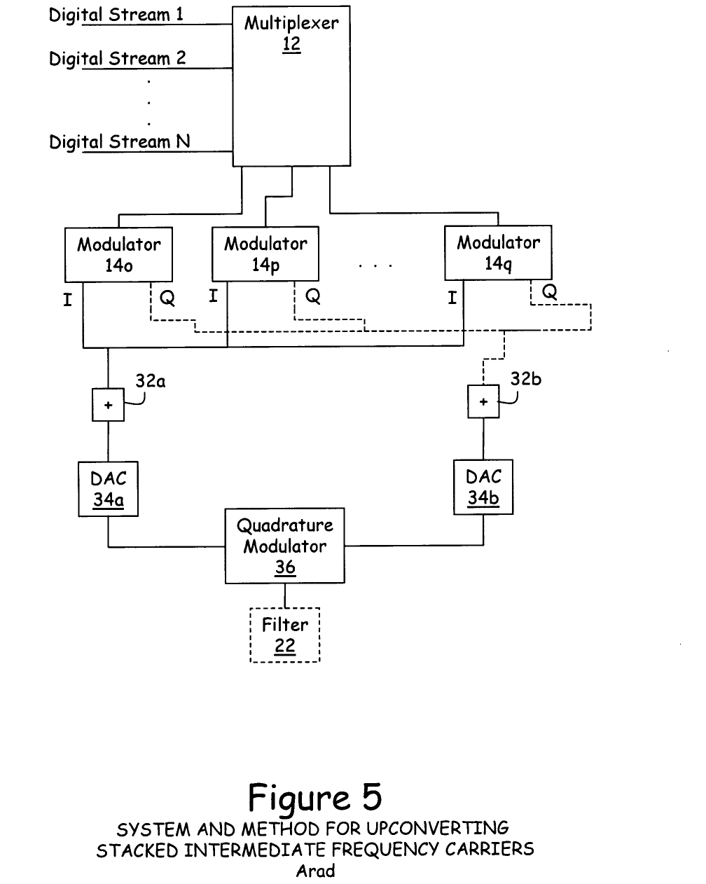

FIG. 5 is a schematic diagram an embodiment of the invention in terms of an I/Q modulation technique in accordance with the invention. First, each of the digital signals is directed to a specific modulator, namely one of the modulators 14o-q. The particular modulator converts the binary data of the particular data stream into a complex baseband signal having a real component and imaginary component. These components are digitally upconverted to a digital intermediate frequency (IF). This can be done with direct digital synthesization techniques.

The result is the formation of two signals. In this embodiment, each of the modulators 14o-q produce an I-signal and a Q-signal, where “I” is the “in-phase” component of the waveform, and “Q” represents the quadrature component, indicative of an IQ modulation known in the art.

It should be noted that each of the modulators 14o-q produces a digital signal upconverted to a different IF. Each of the modulators 14o-q upconverts a particular digital stream and produces a digital upconverted signal targeted to different bandwidths within the broadband output of the system. In this manner, the various individual channels in the broadband signal are produced in the digital domain for each corresponding digital stream that is intended to be broadcast in that subchannel.

The various in-phase, or “I” signals are directed to the summer 32a, while the various quadurature, or “Q” signals, are similarly directed to a summer 32b. In this manner, the summer 32a produces a summation of the various I signals, and the summer 32b produces a summation of the various Q signals.

The outputs of the summers 32a and 32b are relayed to a DAC 34a and a DAC 34b, respectively, where they are each converted to an analog signal. In this case, the signal produced by the DAC 34a is the analog signal representing the summation of the I-signals produced from all the data streams. Similarly, the signal produced by the DAC 34b is the analog signal representing the summation of the Q-signals produced from all the data streams.

The summed I-signals and Q-signals are sent to a quadrature modulator 36. The quadrature modulator 36 upconverts the summed I-signals and Q-signals into a single RF signal centered on a desired RF carrier frequency. In this manner, a number of carrier subchannels are transformed into a broadband signal with a minimal number of analog components.

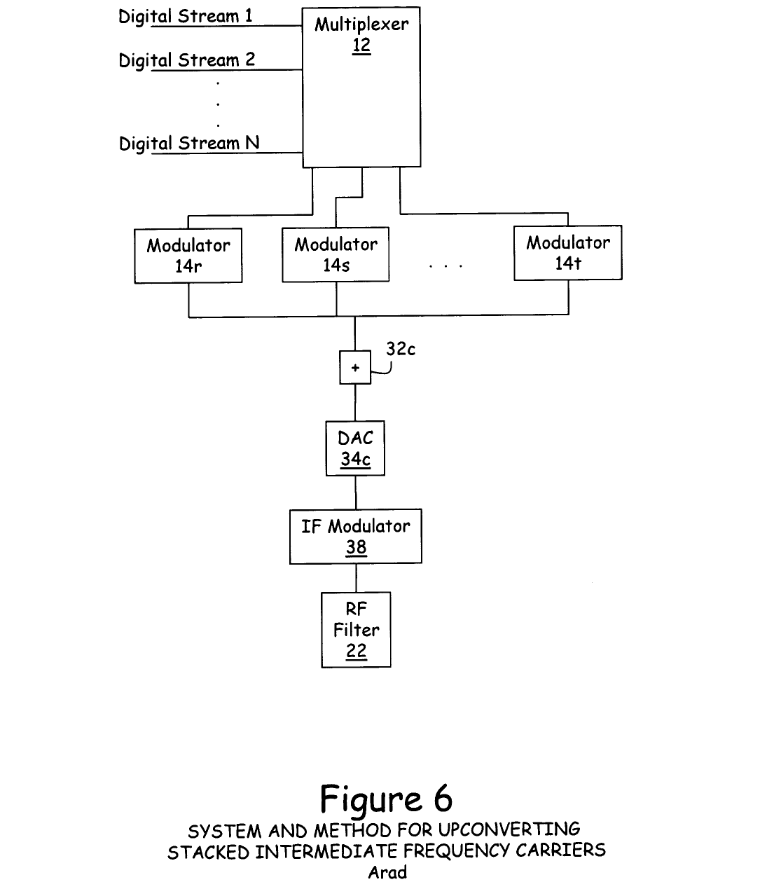

FIG. 6 is a schematic diagram of embodiment of the invention in terms of an alternative modulation technique used with a standard IF modulator in accordance with the invention. Again, each of the digital signals is directed to a modulator, 14r-t. Similar to that above, each modulator converts the binary data into a complex baseband signal having a real component and imaginary component. These components are digitally upconverted to a digital IF with the modulators 14r-t. This can be done using direct digital synthesization techniques and be used to form the single digital modulated signal at the output of each of the modulators 164r-t.

Again, it should be noted that each of the modulators 14r-t produces a digital signal upconverted to a different IF. Each of the modulators 14r-t produces a signal targeted to different bandwidths, reflecting the nature of the outgoing broadband signal.

The modulated signals from the modulators 14r-t are directed to the summer 32c. In this manner, the summer 32c produces a digital summation of the modulated signals produced by the modulators 14r-t, much as in the manner as described above.

The output of the summer 32c is relayed to a DAC 34c, where it is converted to an analog signal. The output of the DAC 34c is then sent to an IF modulator 38. The IF modulator 38 upconverts the summed signal into a single RF signal centered on a desired RF carrier frequency.

It should be noted that the numbers of input channels and modulators are fixed in the preceding disclosure. It should be noted that one skilled in the art would realize that other numbers of channels or streams depicted may be used, and this disclosure should be read as contemplating those situations.

Thus, a system and method for an upconverter for stacked intermediate frequency carriers is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims. Accordingly, what is claimed is:

1. A system for outputting a broadband signal, the broadband signal comprising a first plurality of channel streams, the first plurality of channel streams arriving at the system in a digital format, the system comprising:
a plurality of modulator circuits producing a digital upconverted signal of each of the channel streams;
a summer circuit, coupled to the plurality of modulator circuits, for digitally summing the digital unconverted signals;
a DAC, coupled to the summer circuit, producing an analog signal from the digitally summed upconverted signal; and
an upconverter, coupled to the DAC, for upconverting the signal into another signal centered on a particular frequency.

2. The system of claim 1 wherein the each of the plurality of modulator circuits outputs a single signal.

3. The system of claim 1 wherein the upconverter is an IF modulator.

4. The system of claim 1 further comprising:
a filter, coupled to the upconverter, to band limit the outgoing signal.

5. A system for outputting a broadband signal, the broadband signal comprising a first plurality of channel streams, the first plurality of channel streams arriving at the system in a digital format, the system comprising:
a plurality of modulator circuits producing a digital upconverted signal of each of the channel streams;
a summer circuit, coupled to the plurality of modulator circuits, for digitally summing the digital upconverted signals;
a DAC, coupled to the summer circuit, producing an analog signal from the digitally summed upconverted signal;
an upconverter, coupled to the DAC, for upconverting the signal into another signal centered on a particular frequency; and
a transmitter, coupled to the upconverter, for outputting the plurality of summed signals to a receiver.

6. The system of claim 5 wherein each of the plurality of modulator circuits outputs a single signal.

7. The system of claim 5 wherein the upconverter is an IF modulator.

8. The system of claim 5 further comprising:
a filter, coupled to the upconverter, to band limit the outgoing signal.

9. A system for outputting a broadband signal, the broadband signal comprising a first plurality of channel streams, the first plurality of channel streams arriving at the system in a digital format, the system comprising:
a plurality of modulator circuits producing a digital upconverted signal of each of the channel streams, each of the plurality of modulator circuits having a first and second outputs;
a first summer circuit, coupled to the plurality of first outputs of the plurality of modulator circuits, for digitally summing the first outputs of the modulator circuit;
a second summer circuit, coupled to the plurality of second outputs of the plurality of modulator circuits, for digitally summing the second outputs of the modulator circuit;
a first DAC, coupled to the first summer circuit, producing an analog signal from the digitally summed first outputs;
a second DAC, coupled to the second summer circuit, producing an analog signal from the digitally summed second outputs; and
an upconverter, coupled to the first and the second DAC, for upconverting the summed first signals and the summed second signals into another signal centered on a particular frequency.

10. The system of claim 9 wherein the upconverter is a quadrature modulator.

11. The system of claim 9 further comprising:
a filter, coupled to the upconverter, to band limit the outgoing signal.

12. A system for outputting a broadband signal, the broadband signal comprising a first plurality of channel streams, the first plurality of channel streams arriving at the system in a digital format, the system comprising:
a plurality of modulator circuits producing a digital upconverted signal of each of the channel streams;
a first number of summer circuits, each summer circuit coupled to the plurality of modulator circuits, for digitally summing an output of the modulator circuit;
a number of DACs, each of the second number of DACs coupled to a summer circuit, each DAC producing an analog signal from the digitally summed output of one of the summer circuits; and
a second number of upconverters, each of the second number of upconverters coupled to the number of DACs, for upconverting a signal from the DAC into an output signal centered on a particular frequency;
wherein the second number is less than the first number.

13. A system for outputting a broadband signal, the broadband signal comprising a first plurality of channel streams, the first plurality of channel streams arriving at the system in a digital format, the system comprising:
a plurality of modulator circuits producing a digital upconverted signal of each of the channel streams;
a first number of summer circuits, each summer circuit coupled to the plurality of modulator circuits, for digitally summing an output of the modulator circuit;
a second number of DACs, each of the second number of DACs coupled to a summer circuit, each DAC producing an analog signal from the digitally summed output of one of the summer circuits; and
a number of upconverters, each of the third number of upconverters coupled to the second number of DACs, for upconverting a signal from the DAC into an output signal centered on a particular frequency;
wherein the second number is less than the first number.
